(19) United States
(12) Patent Application Publication
(10) Pub. No.: US 2016/0318188 A1
(43) Pub. Date: Nov. 3, 2016

(54) IMPACT DETECTION SYSTEM FOR ROBOTIC DEVICE

(71) Applicant: AIRBUS GROUP SAS, Paris (FR)

(72) Inventor: Adolfo SUAREZ ROOS, Paris (FR)

(73) Assignee: AIRBUS GROUP SAS, paris (FR)

(21) Appl. No.: 15/107,665

(22) PCT Filed: Dec. 23, 2014
(86) PCT No.: PCT/EP2014/079146

§ 371 Date: Jun. 23, 2016

(30) Foreign Application Priority Data
Dec. 26, 2013 (FR) 1363611

(51) Int. Cl. B25J 13/08; B25J 19/06; B25J 19/00

(52) U.S. Cl. CPC B25J 13/081; B25J 19/0091; B25J 19/063

(57) ABSTRACT

An impact detection system for a robotic device. The system includes a flexible covering element for enveloping part of the robotic device, the covering element defining an inner air volume, at least one sensor for measuring the differential pressure between the pressure in the inner air volume and the pressure outside the covering element, and a detection unit designed to receive the measuring signal of the at least one sensor, to carry out an analysis, on the basis of the measuring signal, in order to detect a sudden variation in the pressure, and to emit a stop signal to the robotic device when such a variation is detected.

### CROSS REFERENCE TO RELATED APPLICATIONS

This application is the National Stage of International Application No. PCT/EP2014/079146, having an International Filing Date of 23 Dec. 2014, which designated the United States of America, and which International Application was published under PCT Article 21(2) as WO Publication No. 2015/097215 A1, and which claims priority from, and the benefit of, French Application. No. 1363611, filed on 26 Dec. 2013, the disclosures of which are incorporated herein by reference in their entireties.

### BACKGROUND

1. Field

The presently disclosed embodiment relates to an impact detection system for a robotic device.

The disclosed embodiment also relates to a robotic device equipped with at least one such detection system.

2. Brief Description of Related Developments

It is known that when a robot shares a workspace with one or more operators, the protection of this or these operator(s) and of the robot becomes a top priority.

Specifically, this robot may, while carrying out a movement such as the rotation of an arm, strike an operator located in the field of movement of this arm. The operator thus struck may be injured if the impact is sufficiently violent.

To guarantee the safety of operators, physical barriers such as cages, or virtual barriers such as optical systems, are commonly implemented.

However, these barriers lead to alterations to the workspace through the creation of areas of restricted access, the placement of numerous visual signs such as floor markings, or even the addition of extra members to ensure the transfer of objects between the area reserved for the robot and the area reserved for operators.

Furthermore, loud acoustic alarms may also be implemented in order to warn the operator that the robot is starting up or of an incursion into the area reserved for the robot.

All of these barriers are costly and tedious to install. Moreover, they limit operators' workspace.

Sensing skins based on matrical distributions of touch sensors that are capable of detecting contact are also known.

However, the fabrication of these detectors is relatively complex and expensive and it is only employed over small areas.

Touch surfaces comprising two conductive or resistive materials for detecting contact via electrical resistivity measurements are also known.

However, the fabrication of these detectors may turn out to be complex and, above all, the measurements may not be uniform and hence not reliable.

The presently disclosed embodiment aims to overcome these various drawbacks of the prior art by proposing an impact detection system for a robot that is simple in design and operation, economical and has very high sensitivity for the measurement of even very low-energy impacts.

Another aspect of the presently disclosed embodiment is a system of this type that quickly and reliably permits the detection of the point of impact.

### SUMMARY

To this end, the disclosed embodiment relates to an impact detection system for a robotic device.

According to the disclosed embodiment, this detection system comprises:

a flexible covering element for enveloping, or clothing, a portion of said robotic device, said covering element delimiting an inner volume of air;

at least one sensor for measuring the differential pressure between the pressure in said inner volume of air and the pressure outside said covering element;

a detection unit configured to receive the measurement signal from said at least one sensor, to carry out, on the basis of said measurement signal, an analysis in order to detect an abrupt variation in said pressure and to transmit a. stop signal to said robotic device when such a variation is detected.

The term “abrupt variation” in pressure is understood to mean a high-frequency variation in this pressure such as that resulting from the generation of a sound wave propagating through said inner volume subsequent to an impact on said covering element.

The pressure outside said covering element is typically the prevailing pressure in the area, such as a room OT hall, in Which the robotic device is placed. This outer pressure will therefore generally, but not necessarily, be the atmospheric pressure.

As said portion of said robotic device moves, the thickness of said covering element is preferably less than 15 mm, and even more preferably less than 10 mm, so as not to limit the movements of said moving part.

Such an impact detection system advantageously allows the safety of robots to be very substantially improved and consequently their safer use in proximity to operators to be authorized.

Specifically, this detection system allows:

all collisions to be detected and the robot to be stopped before irreversible injuries are able to occur, and

the effects of an impact to be reduced by distributing the force of contact over a large surface area and/or by using flexible materials.

Advantageously, such a detection system comprises one or more sensors which are not distributed over the entirety of the skin like the devices of the state of the art, but located at the edges of this skin; fewer sensors are necessary and the wiring of these sensors is easier.

In various particular aspects of this detection system, each having its particular advantages and being subject to numerous possible technical combinations:

this system comprises at least two sensors for measuring the differential pressure.

The implementation of at least two sensors ensures the required redundancy in the event of the failure/malfunction of one of the sensors.

The implementation of three or more sensors, i.e. at least three sensors, allows the impact position to be determined via triangulation.

Having found the impact position with high precision, it then becomes possible to optimally adjust the reaction of the robot and even to take advantage of this information to facilitate the control of the robot.

said covering element comprises an air-permeable flexible material, said material being covered by an impermeable wall on at least one of its sides.

Preferably, said covering element comprises two flexible walls impermeably joined together at their edges and delimiting, between these two walls, an inner volume in which the flexible material is placed.

Purely by way of illustration, the impermeable. flexible wall is made of a flexible plastic material or of rubber.

Advantageously, said air-permeable flexible material is chosen from among the group comprising a foam, an open-cell foam, a fibrous wadding, an elastic component and combinations of these elements.

said covering element is a self-inflating mattress;

said detection unit comprises, for each sensor, an electronic circuit comprising one impedance-matching stage at whose output two resistors are placed in order to separate the signal output by this impedance-matching stage into two signals, each signal being sent to a separate input of a comparator, a detector allowing a signal output by said comparator, corresponding to a variation in pressure over a time Δt, to be measured.

The electronic system may also alternatively be completely analog: the signal from the sensor is digitally filtered in order to obtain the same result.

this system comprises a safety interface intended to be placed between said covering element and said portion of the robotic device, said safety interface, being capable of detecting a pressure applied to said interface and sending an alarm signal to a control unit, said control unit sending a stop signal to said robotic device when it receives such an alarm signal.

Purely by way of illustration, this interface may be produced using a sensing skin comprising, in its thickness, two conductive materials spaced apart from one another which transmit a signal when they come into contact as a result of an impact.

said at least one sensor is intended to be directly mounted on said robotic device or is located remotely with respect to said covering element so as not to form a hard point on said covering element;

this system comprises a probe for measuring the pressure in said inner volume;

this system comprises an inflating device in order maintain a constant pressure P_{operating} in said inner volume.

Advantageously, this pressure P_{operating} is of the order of 3 to 4 bar in order to ensure that the detection system has a high level of sensitivity to impacts.

The presently disclosed embodiment also relates to a robotic assembly comprising a robotic device and a detection system such as described above.

### BRIEF DESCRIPTION OF THE DRAWINGS

Other advantages, aims and particular features of the presently disclosed embodiment will emerge from the following description, given by way of wholly non-limiting example and with regard to the appended drawings in which:

FIG. 1 diagrammatically shows an impact detection system for a robot according to one particular aspect of the presently disclosed embodiment;

FIG. 2 is a diagrammatic view of the detection unit of the system of FIG. 1;

FIG. 3 shows a skin equipped with two sensors of the system of FIG. 1;

FIG. 4 shows a robot a portion of whose articulated arm is covered with a skin such as shown diagrammatically in FIG. 1.

### DETAILED DESCRIPTION

First of all, it is to be noted that the figures are not to scale.

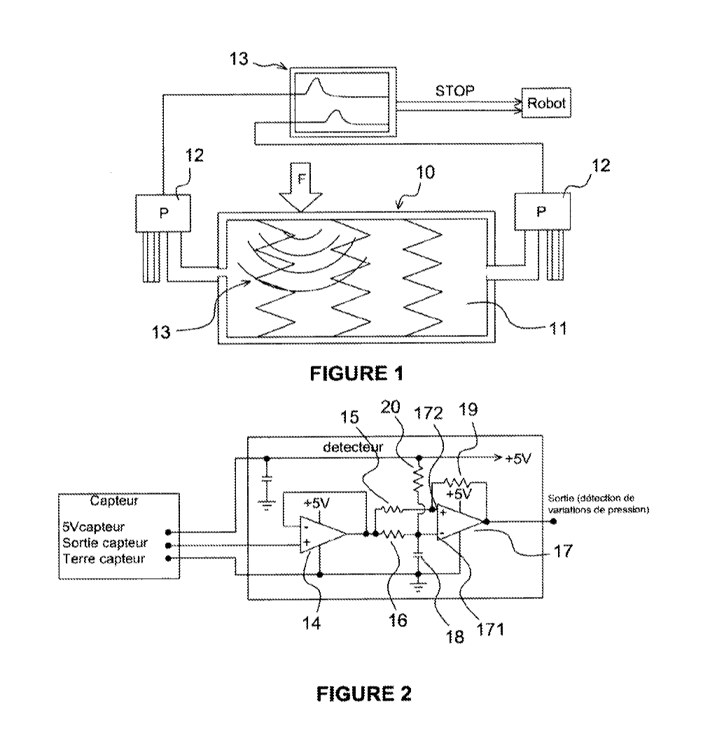

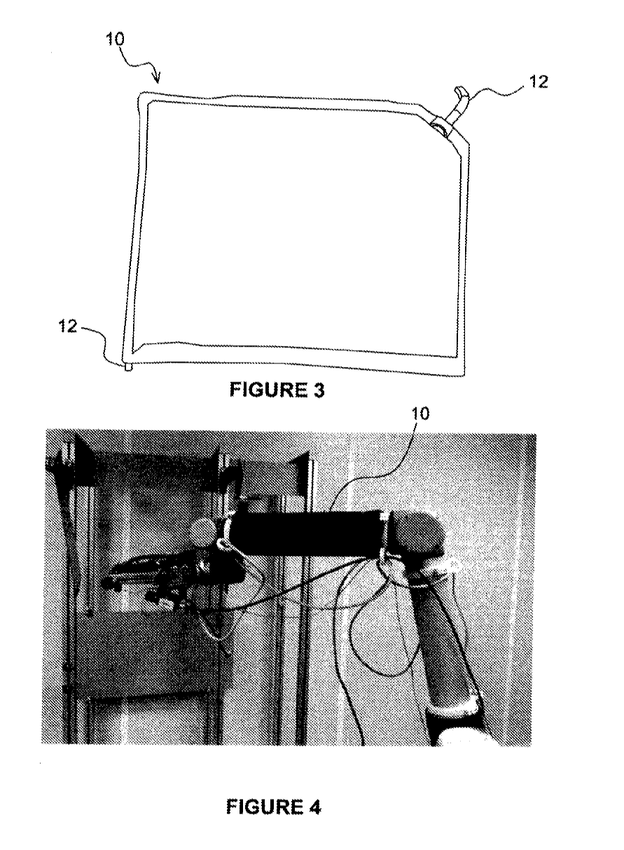

FIGS. 1 to 3 describe an impact detection system for a robot according to one particular aspect of the presently disclosed embodiment. This robot is placed in a building at atmospheric pressure Prₐₜₘₒ.

This system comprises a flexible covering element 10, or sensing skin, for clothing a portion of this robot, such as its arm (not shown), which is liable to collide with an object or a person while moving.

This covering element 10 is here a self-inflating mattress comprising a foam that is packaged in an envelope made of an impermeable plastic material. This self-inflating mattress 10 defines an inner volume 11 of air that has an interior pressure Prᵢₙₜ.

As the covering element 10 is flexible and inflated, it advantageously defines a protective barrier capable of absorbing light impacts.

Moreover, as this covering element 10 automatically maintains its form, it advantageously requires no inflating device and is therefore always operational.

As FIG. 1 shows, the system also comprises two sensors 12 that are remotely located at the ends of the covering element 10 so as not to form a hard point on the outer surface of this element.

These sensors 12 measure the differential pressure between the pressure Prᵢₙₜ in the inner volume 11 of air, defined by the covering element 10, and the atmospheric pressure Prₐₜₘ.

It is thus possible to have access to variations in the pressure of the air enclosed by the covering element 10.

During an impact on the covering element 10, a wave of pressure passes through the interior of the volume delimited by the self-inflating mattress 10, causing a pressure disturbance Which is detected by the two sensors 12.

These measurements are then sent to a detection unit 13 that is configured to receive the measurement signals from the two sensors 12, to carry out, for each signal, an analysis in order to detect an abrupt variation in said pressure and to transmit a stop signal to the robot when such a variation is detected.

As shown in figure for each sensor 12, the detection unit 13 comprises an electronic circuit that is associated uniquely with this sensor and which comprises a first operational amplifier 14 at whose output two resistors 15, 16 are placed, each going to a separate input of a second operational amplifier 17, the values of the resistors 15, 16 being identical or as close as possible.

The inverting input 171 of the second operational amplifier 17 is connected to ground via a capacitor 18, the assembly formed by the resistor 16 and the capacitor 18 forming a low-pass filter at the inverting input 171 of the second operational amplifier 17.

On the inverting input 171 side of the operational amplifier 17, the capacitor 18/resistor 16 assembly removes all of the high frequencies from the signal and only lets low frequencies through.

On the positive input 172 side of the operational amplifier 17, everything gets through, in particular variations in pressure arising from impacts on the covering element 10.

The second operational amplifier 17, connected as a comparator, gives a signal equal to 1 (high level) as output during a pressure variation and does this for the entire duration Δt of this variation. A microcontroller (not shown) then allows the signal output by the second operational amplifier to be measured.

The resistor 19 placed at the output of the second operational amplifier 17 adds a hysteresis to the output, preventing the appearance of oscillations when the two input levels of the second operational amplifier are very close.

Additionally, smoothing is carried out by the capacitor placed between the inverting terminal of the second operational amplifier 17 and ground. This circuit also comprises a pull-up resistor 20, thereby preventing the comparator being triggered by the noise present on the non-inverting input.

This circuit advantageously allows minute pressure variations to be detected and has very high reactivity with a very short rise time. Purely by way of illustration, this rise time is here of the order of 100 nanoseconds.

The signals sent to the comparator 17 are not identical, as one branch of the electronic circuit comprises a capacitor that induces a delay and may therefore vary only slowly. Moreover, a pull-up resistor slightly increases the voltage, so that noise from the sensor does not lead to false positives. As for the second branch of the electronic circuit, it varies rapidly.

Advantageously, this detection system allows the point of impact on the surface of the covering element to be determined.

Furthermore, it is noted that the detection system functions even when it has minor leakages.

It is also observed that variations in the pressure, such as atmospheric pressure, outside said covering element and, for example, linked to meteorological conditions or even as a result of doors being closed quickly, are slow and uniform enough that the detection system does not react.

The use of multiple sensors 12 ensures redundancy in detection, thereby making the detection system more reliable. It also offers the possibility to triangulate the signals sent by the sensors 12 in order to estimate the position of contact on the surface of the covering element.

In one particular aspect in which this system comprises three sensors for measuring the differential pressure C₁, C₂ and C₃ and assuming that the sensor C₁ is the first to detect a pressure disturbance, the sensor C₂ is the second and the sensor C₃ the third to detect this disturbance, then the differences in measurement time are (t₂−t₁) and (t₃−t₁), respectively.

Taking the distance separating the point of impact from the position of the sensor C₁ to be r, it is deduced therefrom that the distances separating the point of impact from the sensors C₂ and C₃ are r+c×(t₂−t₁) and r+c×(t₃−t₁), respectively, where c is the speed of propagation of the wave through the inner volume of the covering element.

For the curved elements, the wave is taken to propagate over a virtual median surface.

The intersection of the curves obtained by taking a spacing Δr around the distance r allows the position of the point of impact to be obtained in a very short time and with very high precision via an iterative algorithm.

What is claimed is

1. An impact detection system for a robotic device, comprising:
a flexible covering element far enveloping a portion of said robotic device, said covering element delimiting an inner volume of air;
at least one sensor for measuring the differential pressure between the pressure in said inner volume of air and the pressure outside said covering element;
a detection unit configured to receive the measurement signal from said at least one sensor, to carry out, on the basis of said measurement signal, an analysis in order to detect an abrupt variation in said pressure and to transmit a stop signal to said robotic device when such a variation is detected; and
said covering element comprises an air-permeable flexible material, said material being covered by an impermeable wall on at least one of its sides, said covering element forming a self-inflating mattress.

2. The detection system as claimed in claim 1, further comprises at least two sensors for measuring the differential pressure.

3. The detection system as claimed in claim 1, wherein said air-permeable flexible material is chosen from among the group comprising a foam, an open-cell foam, a fibrous wadding, at least one elastic component and combinations of these elements.

4. The detection system as claimed in claim 1, wherein said detection unit comprises, for each sensor, an electronic circuit comprising one impedance-matching stage at whose output two resistors are placed in order to separate the signal output by said one impedance-matching stage into two signals, each signal being sent to a separate input of a comparator, a detector allowing a signal output by said comparator, corresponding to a variation in pressure over a time Δt, to be measured.

5. The detection system as claimed in claim 1, further comprises a safety interface intended to be placed between said covering element and said portion of the robotic device, said safety interface being capable of detecting a pressure applied to said interface and sending an alarm signal to a control unit, said control unit sending a stop signal to said robotic device when it receives such an alarm signal.

6. The detection system as claimed in claim 1, wherein at least one sensor is intended to be directly mounted on said robotic device or is located remotely with respect to said covering element so as not to form a and point on said covering element.

7. The detection system as claimed in claim 1, further comprises a probe for measuring the pressure in said inner volume.

8. The detection system as claimed in claim 1, further comprises an inflating device in order to maintain a constant pressure P_{operating} in said inner volume.

9. A robotic assembly comprising a robotic device and a detection system as claimed in claim 1.
